(19) United States
(12) Patent Application Publication
(10) Pub. No.: US 2011/0185790 A1
(43) Pub. Date: Aug. 4, 2011

(54) Leakage Detection Method and System Using Camera Image

(75) Inventors: Young-Chul Choi, Daejeon (KR); Jin-Ho Park, Daejeon (KR); Hyeong Seop Jeon, Daejeon (KR); Ki-Sung Son, Daejeon (KR); Doo-Byung Yoon, Daejeon (KR); Sung Hwan Shin, Daejeon (KR)

(73) Assignees: Korea Atomic Energy Research Institute, Daejeon (KR); Korea Hydro & Nuclear Power Co., Ltd., Seoul (KR)

(21) Appl. No.: 12/893,048

(22) Filed: Sep. 29, 2010

(30) Foreign Application Priority Data
Feb. 2, 2010 (KR) 10-2010-0009547

(51) Int. Cl. G01M 3/04

(52) U.S. Cl. 73/40

(57) ABSTRACT

Provided is a leakage detection system and method using an image that may detect a leakage of high temperature high pressure steam using an image. The leakage detection method may include: obtaining an image of a target where a leakage of high temperature high pressure steam occurs; detecting, in the obtained image, an edge image before the leakage occurs and an edge image after the leakage occurs; detecting only a leakage edge image by comparing the edge image before the leakage occurs and the edge image after the leakage occurs; removing noise from the leakage edge image; and displaying the leakage edge image in which the noise is removed.

### CROSS-REFERENCE TO RELATED APPLICATION

This application claims the benefit of Korean Patent Application No. 10-2010-0009547, filed on Feb. 2, 2010, in the Korean Intellectual Property Office, the disclosure of which is incorporated herein by reference.

### BACKGROUND

A method and system are disclosed for detecting a leakage using a camera image.

More specifically, a leakage detection method and system are disclosed that may use an image, that may photograph an image of a target using a camera, that may detect an edge of the image, and that may compare an edge image before a leakage occurs and an edge image after the leakage occurs, thereby detecting a leakage.

### DESCRIPTION OF THE RELATED ART

In a thermoelectric power plant, a nuclear power plant, and the like, high temperature high pressure steam can be transported through piping and the like, and thereby can be used for power generation. In Mihama Nuclear Power Plant 3 of Japan in August of 2004, a side pipe rupture of a turbine caused the high temperature high pressure steam to be externally expelled, which resulted in causing a number of casualties, 4 deaths and 7 injured.

Currently, many leakage detection systems installed in nuclear power plants use an acoustic emission sensor.

In this case, a corresponding leakage detection system can detect a leakage only when an acoustic emission sensor is directly attached to a pipe. Accordingly, when a number of pipes to be monitored increases, a number of sensors to be attached to the pipes may increase. Also, a system complexity may increase. In addition, as the number of sensors increases, performance of a monitoring system needs to be enhanced to perform real-time monitoring. In addition, the increase in the number of sensors may increase costs.

### SUMMARY OF THE DISCLOSURE

A leakage detection method and system are disclosed that may use an image that may easily detect, using an image of a camera, heat shimmer resulting from a leakage that cannot be visually and easily detectable, and thereby verify the leakage.

A leakage detection method and system are disclosed that may use an image that enables real-time monitoring using an inexpensive camera.

A leakage detection method and system are disclosed that may use an image that may monitor a relatively wide area and easily find a leakage location.

A leakage detection system are disclosed that may use an image, including: an image obtainment unit to obtain an image of a target where a leakage of high temperature high pressure steam occurs; an edge detection unit to detect, in the obtained image, an edge image before the leakage occurs and an edge image after the leakage occurs; a comparison and detection unit to compare the edge image before the leakage occurs and the edge image after the leakage occurs, and to detect only a leakage edge image; and a display unit being connected to the comparison and detection unit to display the leakage edge image. Only the leakage edge image may be displayed on the display unit.

The leakage detection system may further include a noise removal unit to remove noise from the leakage edge image.

The image obtainment unit may include a camera.

The edge detection unit may include: a preprocessing module to convert the image to a gray-scale image, and to control a brightness; and an edge detection module to detect an edge of the target in the gray-scale image.

A disclosed leakage detection method may include: obtaining an image of a target where a leakage of high temperature high pressure steam occurs; detecting, in the obtained image, an edge image before the leakage occurs and an edge image after the leakage occurs; detecting only a leakage edge image by comparing the edge image before the leakage occurs and the edge image after the leakage occurs; removing noise from the leakage edge image; and displaying the leakage edge image in which the noise is removed.

The detecting of the leakage image may include detecting a leakage edge image of heat shimmer occurring due to the leakage, and comparing the edge image before the leakage occurs and the edge image after the leakage occurs to thereby detect only the leakage edge image.

The detecting of the edge image may be performed using a Canny edge detection scheme.

The removing of the noise may be performed using morphological filtering.

The disclosed leakage detection method and system may easily detect, using an image of a camera, heat shimmer that cannot be visually and easily detectable when the heat shimmer occur due to a leakage. Accordingly, it is possible to prevent casualties that may occur due to the leakage of high temperature high pressure steam.

Also, the disclosed leakage detection method and system may monitor in real time whether a leakage occurs using an inexpensive camera. Accordingly, it is possible to save on costs.

Also, the disclosed leakage detection method and system using an image that may monitor a relatively wide area using a plurality of cameras, and may also easily find a leakage location and a leakage direction.

### BRIEF DESCRIPTION OF THE DRAWINGS

These and/or other aspects, features, and advantages of the disclosure will become apparent and more readily appreciated from the following description of exemplary embodiments, taken in conjunction with the accompanying drawings of which:

FIG. 1 is a block diagram illustrating a configuration of a disclosed leakage detection system using an image;

FIG. 2 is a flowchart illustrating a disclosed leakage detection method using an image;

FIG. 3 is a diagram illustrating a configuration of a disclosed testing apparatus employing a leakage detection method and system using an image;

FIG. 4 illustrates a schliere image of a heat source photographed from the test of FIG. 3;

FIG. 5 illustrates a test result of a leakage image;

FIG. 6 is a diagram illustrating a test configuration of a disclosed leakage detection method and system using an image;

FIG. 7A and FIG. 7B respectively illustrate an original image and a post-image processing result in the disclosed leakage detection system when a leakage occurs in a pipe.

### DETAILED DESCRIPTION OF THE PRESENTLY PREFERRED EMBODIMENTS

Reference will now be made in detail to exemplary embodiments wherein like reference numerals refer to the like elements throughout.

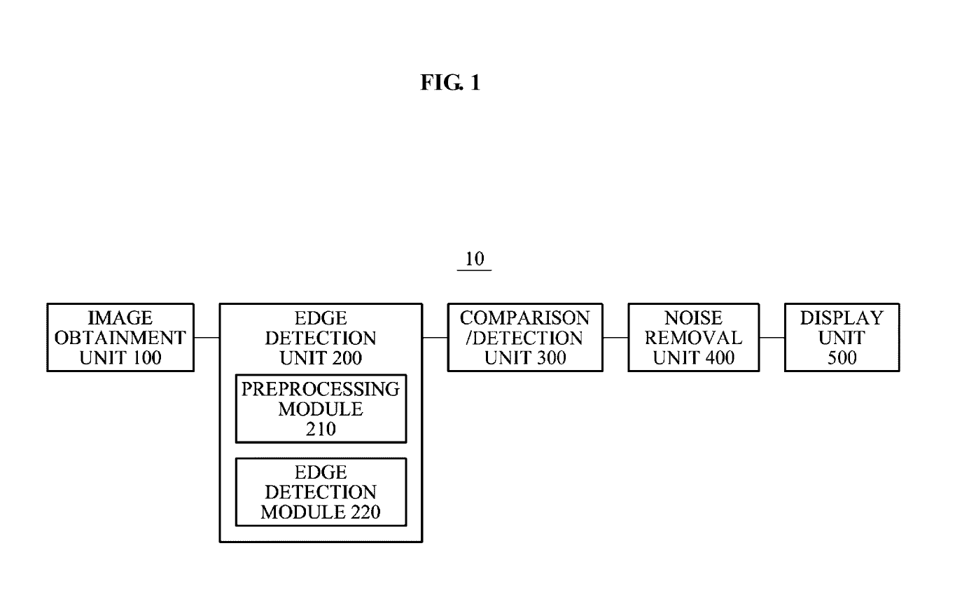

FIG. 1 is a block diagram illustrating a configuration of a disclosed leakage detection system 10 using an image.

Referring to FIG. 1, the leakage detection system 10 may include an image obtainment unit 100, an edge detection unit 200, a comparison and detection unit 300, a noise removal unit 400, and a display unit 500.

The image obtainment unit 100 may obtain an image of a target where a leakage of high temperature high pressure steam occurs. The image obtainment unit 100 may include, for example, a camera. The camera may obtain an original image by photographing an area of the target desired to be measured.

An inexpensive video camera capable of a frame rate of 30 frames per second (fps) may be used as the camera. For example, the camera used for the image obtainment unit 100 may be a video camera having a frame rate of 30 fps and a resolution of 640×480 pixels. The camera may satisfy specifications for verifying heat shimmer.

The target may be a construction structure such as a piping and the like installed in a building, a bridge, a power plant, and the like. The target may also be a construction structure such as a piping installed in a nuclear power plant or a thermoelectric power plant through which high temperature high pressure steam or gas passes.

When a steam leakage occurs in a pipe, the leaked steam may have high temperature and high pressure and thus, may cause a background behind a leakage point to appear shimmery.

A heat shimmer may occur in a particular location due to a refractive index of light being different caused by a difference in air temperature at the particular location. An example of schliren is when the sun is shining down, and an air stream may rise up shimmering like a flame around the ground.

A phenomenon where a rear background image shimmers due to the heat shimmer may be photographed using the camera of the image obtainment unit 100. The leakage detection system 10 may detect the leakage of the high temperature high pressure steam based on the photographed phenomenon.

Specifically, when the leakage occurs, the steam or water may leak from a corresponding pipe and the background may appear shimmery due to heat, which may cause a minute change in an image obtained using the image obtainment unit 100. An image containing the above change may be detected by the image obtainment unit 100.

The edge detection unit 200 may be connected to the image obtainment unit 100 to detect, in the obtained image, an edge image before the leakage occurs and an edge image after the leakage occurs.

The edge detection unit 200 may include a preprocessing module 210 and an edge detection module 220 and thereby preprocess an original image photographed using the camera of the image obtainment unit 100.

The preprocessing module 210 may convert, to a gray-scale image, a color image photographed by the image obtainment unit 100, and may control a brightness.

The edge detection module 220 may detect an edge of the target in the gray-scale image converted by the preprocessing module 210. Whether a leakage occurs may be determined by obtaining, using the camera, the edge of the target to be measured through image processing, and by measuring a change in an edge area occurring due to the heat shimmer.

In the present embodiment, a Canny edge detection algorithm widely used for edge detection may be employed.

The comparison and detection unit 300 may be connected to the edge detection unit 200 to compare the edge image before the leakage occurs and the edge image after the leakage occurs, and to detect only a edge image occurring due to the leakage (leakage edge image).

Specifically, the edge detection unit 200 may detect an edge image in a normal state and an edge image corresponding to a case where the leakage occurs. The comparison and detection unit 300 may compare the detected two edge images and obtain a difference between the two edge images. Accordingly, only the edge image occurring due to the leakage may remain, whereby it is possible to determine whether the leakage occurs.

For example, in a normal state, nothing may show up on an image processing screen. When the leakage occurs, an image where the leakage occurs may show up due to the difference between two images.

The image may be affected by environmental factors, particularly, by a lighting. Accordingly, when noise is included in the image, the noise may cause a serious error in a leakage detection. To overcome the above issue, the leakage detection system 10 may further include the noise removal unit 400.

The noise removal unit 400 may remove the noise in the leakage edge image. For example, the noise removal unit 400 may remove the noise using morphological filtering.

The leakage edge image in which the noise is removed by the noise removal unit 400 may be displayed on the display unit 500. A user may verify the leakage edge image displayed on the display unit 500. When the leakage edge image is detected, the detected leakage edge image may be immediately reported to the user using sound or visual information.

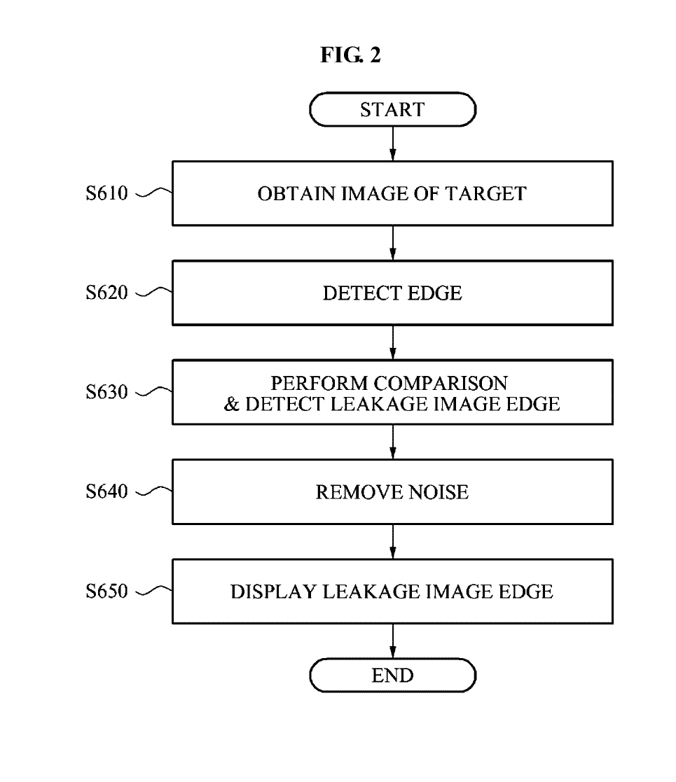

FIG. 2 is a flowchart illustrating a disclosed leakage detection method using an image. Hereinafter, the leakage detection method by the leakage detection system 10 configured as above will be described with reference to FIG. 2.

In operation S610, an image of a pipe corresponding to a target may be obtained using the camera of the image obtainment unit 100.

In operation S620, after converting a color image to a gray-scale image and controlling a brightness using the preprocessing module 210 of the edge detection unit 200, an edge of the image may be detected using the edge detection module 220.

The edge detection may be performed using a Canny edge detection scheme. According to the Canny edge detection scheme, an amount of data may be reduced, meaningless data may be eliminated, and structural information of the image may be maintained.

Hereinafter, the Canny edge detection scheme will be briefly described. The Canny edge detection scheme may perform an equalization using a Gaussian filter to reduce noise, and may calculate a gradient. The Canny edge detection scheme may apply a non-maximum suppression based on a direction of the calculated gradient. The edge detection may be performed using a hysteresis scheme.

When the edge detection of the image is completed, the comparison and detection unit 300 may compare an edge image of the target in a normal state and a leakage edge image of the target when the leakage occurs. When a difference exists between two edge images, the comparison and detection unit 300 may detect only the leakage signal edge image in operation S630.

Noise may exist in the detected leakage edge image. Accordingly, the noise removal unit 400 may remove the noise in operation S640. Here, the noise may be removed through morphological filtering. The morphological filtering corresponds to a scheme of removing the noise by consecutively performing an erosion and a dilation with respect to the corresponding image.

In operation S650, the leakage edge image in which the noise is removed may be displayed on the display unit 500.

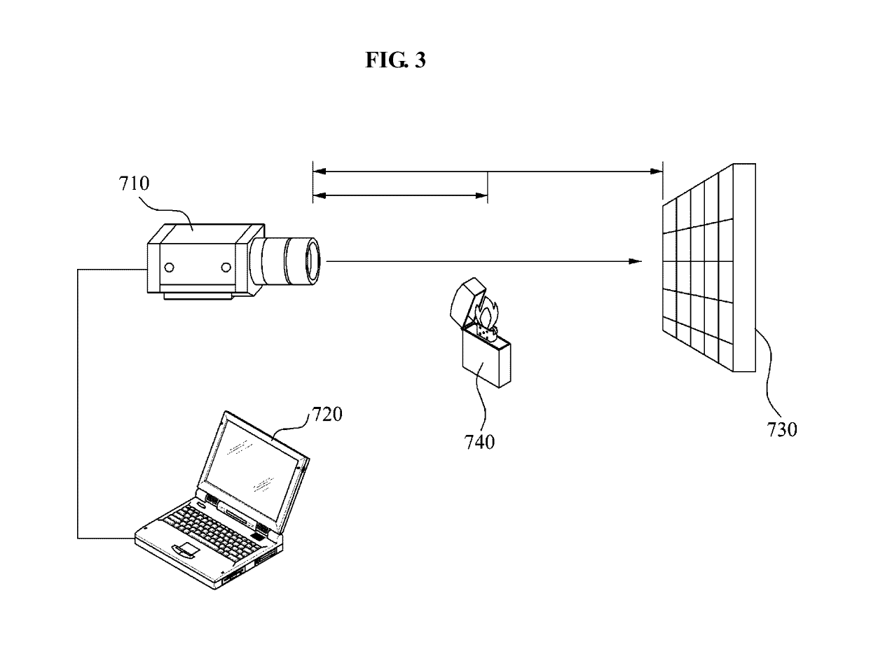

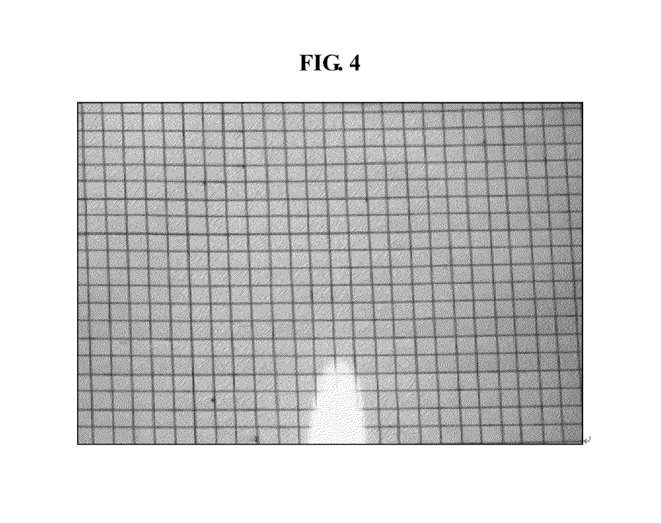

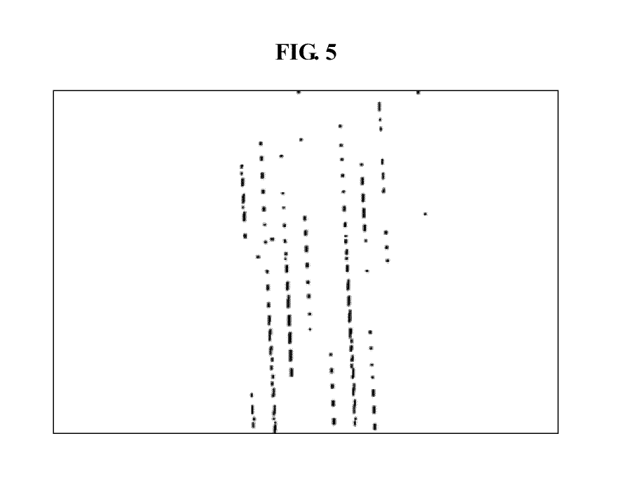

A test for verifying an effect of a leakage detection method and system using an image. FIG. 3 is a diagram illustrating a configuration of a testing apparatus, FIG. 4 illustrates an image of a heat source photographed from the test of FIG. 3, and FIG. 5 illustrates a test result of a leakage edge image.

Referring to FIG. 3, when a leakage of high temperature high pressure steam or gas occurs, heat shimmer occur and thus, the test was performed using a heat source 740. A camera 710 being capable of a frame rate of 30 frames per second (fps) and having a resolution of 640×480 pixels was used. A lighter corresponding to the heat source 740 was disposed between the camera 710 and a grid-patterned paper 730. The grid-patterned paper 730 was used to obtain an accurate test result.

Referring to FIG. 4, a heat shimmer image occurring due to the heat source 740 was photographed using the camera 710. Specifically, based on the heat shimmer image, it is possible to be aware that a visual change occurred in a background due to the heat shimmer.

Referring to FIG. 5, when image processing is performed using an image processing computer 720 according to the leakage detection method, a difference between the obtained image and a reference image, that is, only a change in the image occurring due to the heat shimmer may be displayed.

Referring again to FIG. 5, the image shimmered due to the heat shimmer occurs in a point where the heat occurs. Also, a thermal travel path can be verified.

To perform a comparison with the test result of the leakage detection method and system using the image, the heat shimmer were photographed using a thermal image camera.

It was verified from an image photographed using the thermal image camera that the heat generated from a lighter was distributed. However, since an image obtained using the thermal image camera displays a temperature distribution based on an ignition point where the temperature is highest, it may be insufficient to verify a migration of a relatively low temperature heat and it may be difficult to perform monitoring in real time.

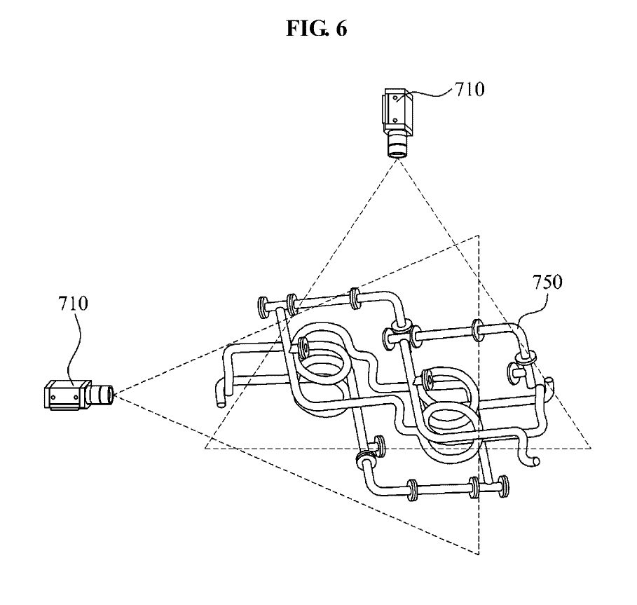

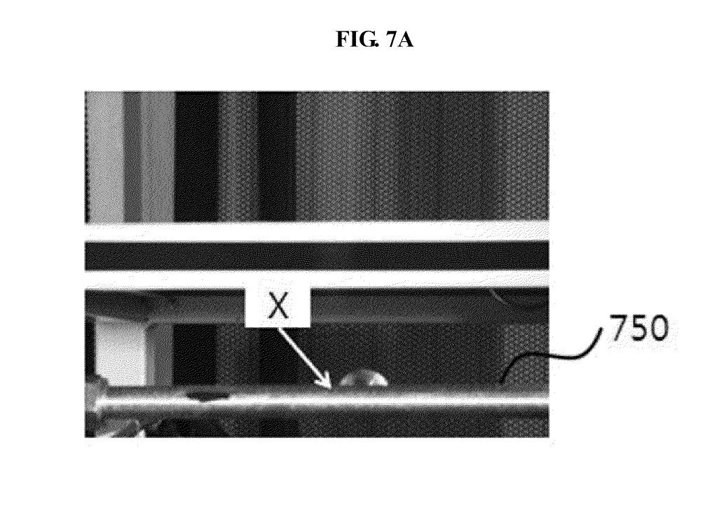

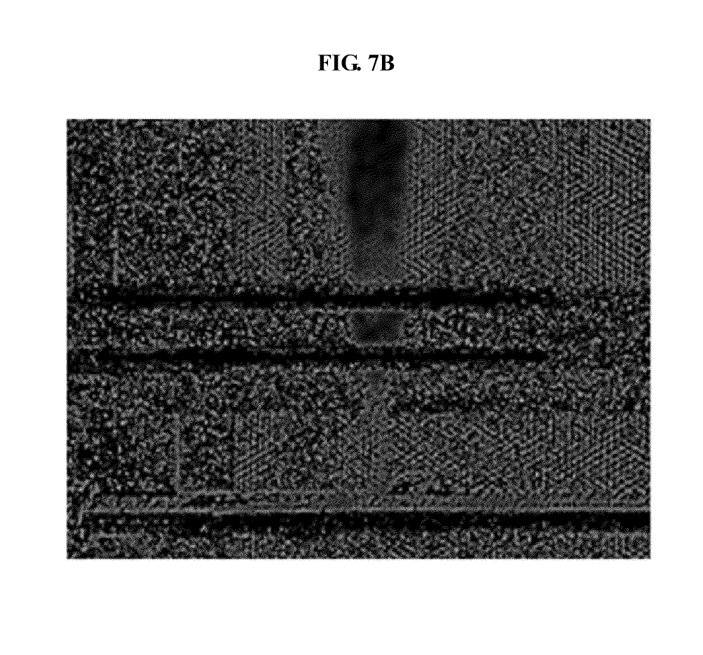

Using a pipe having an actual leakage, a test was performed using a disclosed leakage detection method and system using an image. FIG. 6 illustrates the disclosed test configuration of a leakage detection method and system using an image, and FIG. 7A and FIG. 7B respectively illustrate an original image and a post-image processing result when a leakage occurs in a piping in the disclosed leakage detection system.

Referring to FIG. 6, when a plurality of pipes 750 are arranged in a complex structure, a plurality of cameras 710 may be disposed to photograph different planes. A relatively wide area may be monitored by installing the plurality of cameras 710. A camera being capable of a frame rate of 30 fps and having a resolution of 640×480 pixels was employed for the test.

A leakage portion was marked on one point of the plurality of pipes 750, steam passed the leakage portion through the plurality of pipes 750, and a camera among the plurality of cameras 710 photographed the marked leakage portion. FIG. 7A illustrates an original image of the plurality of pipes 750 where a leakage location X is marked. It can be known from the original image of FIG. 7A that the steam leakage was not visually detected in the leakage location X.

Image processing was performed on the original image using the disclosed leakage detection method and system. FIG. 7B illustrates the result of the image processing. Referring to FIG. 7B, the heat shimmer occurring due to the steam leakage was easily and visually verified in the leakage location X of the plurality of pipes 750. In addition, it is possible to easily and visually verify the leakage direction in addition to the leakage location X of the pipe 750.

As described above, there may be provided a leakage detection method and system using an image that may detect a minute change in an image occurring due to a leakage, and may find a leakage location and verify a transport path of heat. In addition, since a relatively wide area may be monitored by installing a plurality of inexpensive cameras, it is possible to save on costs.

Although a few exemplary embodiments have been shown and described, this disclosure is not limited to the described exemplary embodiments. Instead, it would be appreciated by those skilled in the art that changes may be made to these exemplary embodiments without departing from the principles and spirit of this disclosure, the scope of which is defined by the claims and their equivalents.

1. A leakage detection system using an image, comprising:
an image obtainment unit to obtain an image of a target where a leakage of high temperature high pressure steam occurs;
an edge detection unit to detect, in the obtained image, an edge image before the leakage occurs and an edge image after the leakage occurs;
a comparison and detection unit to compare the edge image before the leakage occurs and the edge image after the leakage occurs, and to detect only a leakage edge image; and
a display unit being connected to the comparison and detection unit to display the leakage edge image,
wherein only the leakage edge image is displayed on the display unit.

2. The leakage detection system of claim 1, further comprising:
a noise removal unit to remove noise from the leakage edge image.

3. The leakage detection system of claim 1, wherein the image obtainment unit comprises a camera.

4. The leakage detection system of claim 1, wherein the edge detection unit comprises:
a preprocessing module to convert the image to a gray-scale image, and to control a brightness; and
an edge detection module to detect an edge of the target in the gray-scale image.

5. A leakage detection method using an image, the method comprising:
obtaining an image of a target where a leakage of high temperature high pressure steam occurs;
detecting, in the obtained image, an edge image before the leakage occurs and an edge image after the leakage occurs;
detecting only a leakage edge image by comparing the edge image before the leakage occurs and the edge image after the leakage occurs;
removing noise from the leakage edge image; and
displaying the leakage edge image in which the noise is removed.

6. The method of claim 5, wherein the detecting of the leakage image comprises detecting a leakage edge image of heat shimmer occurring due to the leakage, and comparing the edge image before the leakage occurs and the edge image after the leakage occurs to thereby detect only the leakage edge image.

7. The method of claim 5, wherein the detecting of the edge image is performed using a Canny edge detection scheme.

8. The method of claim 5, wherein the removing of the noise is performed using morphological filtering.
